(19) United States
(12) Patent Application Publication
(10) Pub. No.: US 2026/0346235 A1
(43) Pub. Date: Nov. 5, 2026

(54) STABLE HIGH-ENTROPY RUTHENIUM-BASED OXIDES FOR ACIDIC OXYGEN EVOLUTION REACTION (OER)

(71) Applicant: Toyota Motor Engineering & Manufacturing North America, Inc., Plano, TX (US)

(72) Inventors: Siwen Wang, Livonia, MI (US); Li Qin Zhou, Okemos, MI (US); Chen Ling, Troy, MI (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 19/196,936

(22) Filed: May 2, 2025

(51) Int. Cl. B01J 23/644; B01J 35/45; C25B 1/04; C25B 9/19; C25B 11/081

(52) U.S. Cl. CPC B01J 23/6445; B01J 35/45; C25B 1/04; C25B 9/19; C25B 11/081

(57) ABSTRACT

Disclosed herein are oxygen evolution reaction (OER) catalyst materials which are stable in acidic media for use in electrochemical devices such as water electrolyzers. The oxygen evolution reaction (OER) catalyst materials comprise a quaternary-doped ruthenium oxide of formula Ruₓ(M1M2M3M4)₁₋ₓO₂, wherein M1 is antimony (Sb), and M2, M3, and M4 are each selected from chromium (Cr), titanium (Ti), copper (Cu), niobium (Nb), tungsten (W), gold (Au), or molybdenum (Mo), or wherein M1, M2, M3, and M4 are each selected from chromium (Cr), titanium (Ti), copper (Cu), niobium (Nb), tungsten (W), gold (Au), or molybdenum (Mo), and x is in the range of 0.2 to 1.0.

### TECHNICAL FIELD

The present disclosure generally relates to acid-stable oxygen evolution reaction (OER) catalyst materials comprising quaternary-doped ruthenium-based oxide nanoparticles, proton exchange membrane systems, and water electrolyzer devices employing acid stable oxygen evolution reaction (OER) catalyst materials.

### BACKGROUND

Water electrolysis (WE) using the hydrogen evolution reaction (HER) is widely recognized as a promising method for clean and sustainable hydrogen production. Currently, dominant alkaline-based water electrolysis encounters challenges including high ohmic resistance, limited current density, and low efficiency. Proton exchange membrane (PEM) electrolysis provides efficient proton transfers and can effectively tackle the above challenges. The sluggish oxygen evolution reaction (OER) in acid has been a major long-existing obstacle in PEM systems and has therefore attracted great research interest. Iridium dioxide (IrO₂) is currently considered the only practical OER electrocatalyst in PEM devices due to its high activity and durability. However, the high cost and low global reserve of iridium (Ir) limit its large-scale applications. Less-expensive catalysts for acidic OER are in great demand.

RuO₂ (ruthenium dioxide) has been recognized as an attractive alternative to iridium dioxide (IrO₂) for acidic OER due to its lower cost. While RuO₂ presents higher OER activity than IrO₂, RuO₂ is generally less stable than IrO₂ in acidic conditions due to degradation of RuO₂ in acidic OER and its long-term stability remains a challenge. In recent years, various strategies, i.e., lattice doping, strain effect, and morphology and structure modifications, have been tried to improve the performance of RuO₂ in acidic media. It is desirable to improve the stability of RuO₂ for acidic oxygen evolution reactions.

### SUMMARY

This section provides a general summary of the disclosure and is not a comprehensive disclosure of its full scope or all of its features.

In various aspects, the present teachings provide an oxygen evolution reaction (OER) catalyst material comprising a quaternary-doped ruthenium dioxide nanoparticles of, wherein: M1 is antimony (Sb); M2, M3, and M4 are each selected from chromium (Cr), titanium (Ti), copper (Cu), niobium (Nb), tungsten (W), gold (Au), or molybdenum (Mo); and x is in a range of 0.2 to 1.0. The quaternary-doped ruthenium dioxide comprises a tetragonal rutile-type lattice structure. The oxygen evolution reaction (OER) catalyst material is stable in acidic media.

In some examples, in formula Ruₓ(M1M2M3M4)₁₋ₓO₂, x may be 0.2. In some examples, the quaternary-doped ruthenium dioxide may be Ru_{0.2}M1_{0.2}M2_{0.2}M3_{0.2}M4_{0.2}O₂. The quaternary-doped ruthenium dioxide of the oxygen evolution reaction (OER) catalyst material may be selected from:
(a) Ru_{0.2}Sb_{0.2}Cr_{0.2}Ti_{0.2}Cu_{0.2}O₂,
(b) Ru_{0.2}Sb_{0.2}Cr_{0.2}Ti_{0.2}Nb_{0.2}O₂,
(c) Ru_{0.2}Sb_{0.2}Cr_{0.2}Ti_{0.2}Au_{0.2}O₂,
(d) Ru_{0.2}Sb_{0.2}Cr_{0.2}Ti_{0.2}Mo_{0.2}O₂,
(e) Ru_{0.2}Sb_{0.2}Cr_{0.2}Cu_{0.2}Nb_{0.2}O₂,
(f) Ru_{0.2}Sb_{0.2}Cr_{0.2}Cu_{0.2}W_{0.2}O₂,
(g) Ru_{0.2}Sb_{0.2}Cr_{0.2}Cu_{0.2}Au_{0.2}O₂,
(h) Ru_{0.2}Sb_{0.2}Cr_{0.2}Cu_{0.2}Mo_{0.2}O₂,
(i) Ru_{0.2}Sb_{0.2}Cr_{0.2}Nb_{0.2}Au_{0.2}O₂,
(j) Ru_{0.2}Sb_{0.2}Cr_{0.2}W_{0.2}Au_{0.2}O₂,
(k) Ru_{0.2}Sb_{0.2}Cr_{0.2}Au_{0.2}Mo_{0.2}O₂,
(l) Ru_{0.2}Sb_{0.2}Ti_{0.2}Cu_{0.2}Nb_{0.2}O₂,
(m) Ru_{0.2}Sb_{0.2}Ti_{0.2}Cu_{0.2}W_{0.2}O₂,
(n) Ru_{0.2}Sb_{0.2}Ti_{0.2}Cu_{0.2}Au_{0.2}O₂,
(o) Ru_{0.2}Sb_{0.2}Ti_{0.2}Cu_{0.2}Mo_{0.2}O₂,
(p) Ru_{0.2}Sb_{0.2}Ti_{0.2}Nb_{0.2}Au_{0.2}O₂,
(q) Ru_{0.2}Sb_{0.2}Ti_{0.2}W_{0.2}Au_{0.2}O₂,
(r) Ru_{0.2}Sb_{0.2}Ti_{0.2}Au_{0.2}Mo_{0.2}O₂,
(s) Ru_{0.2}Sb_{0.2}Cu_{0.2}Nb_{0.2}W_{0.2}O₂,
(t) Ru_{0.2}Sb_{0.2}Cu_{0.2}Nb_{0.2}Au_{0.2}O₂,
(u) Ru_{0.2}Sb_{0.2}Cu_{0.2}Nb_{0.2}Mo_{0.2}O₂,
(v) Ru_{0.2}Sb_{0.2}Cu_{0.2}W_{0.2}Au_{0.2}O₂, or
(w) Ru_{0.2}Sb_{0.2}Cu_{0.2}Au_{0.2}Mo_{0.2}O₂.

In some aspects, the present disclosure provides an oxygen evolution reaction (OER) catalyst material comprising nanoparticles of quaternary-doped ruthenium dioxide of formula Ruₓ(M1M2M3M4)₁₋ₓO₂, wherein: M1, M2, M3, and M4 are each selected from chromium (Cr), titanium (Ti), copper (Cu), niobium (Nb), tungsten (W), gold (Au), or molybdenum (Mo); and x is in a range of 0.2 to 1.0. The quaternary-doped ruthenium dioxide comprises a tetragonal rutile-type lattice structure. The oxygen evolution reaction (OER) catalyst material is stable in acidic media.

In some examples, in formula Ruₓ(M1M2M3M4)₁₋ₓO₂, x may be 0.2. In some examples, the quaternary-doped ruthenium dioxide may be Ru_{0.2}M1_{0.2}M2_{0.2}M3_{0.2}M4_{0.2}O₂. The quaternary-doped ruthenium dioxide of the oxygen evolution reaction (OER) catalyst material may be selected from:
(aa) Ru_{0.2}Cr_{0.2}Ti_{0.2}Cu_{0.2}Nb_{0.2}O₂,
(bb) Ru_{0.2}Cr_{0.2}Ti_{0.2}Cu_{0.2}W_{0.2}O₂,
(cc) Ru_{0.2}Cr_{0.2}Ti_{0.2}Cu_{0.2}Au_{0.2}O₂,
(dd) Ru_{0.2}Cr_{0.2}Ti_{0.2}Cu_{0.2}Mo_{0.2}O₂,
(ee) Ru_{0.2}Cr_{0.2}Ti_{0.2}Nb_{0.2}Au_{0.2}O₂,
(ff) Ru_{0.2}Cr_{0.2}Ti_{0.2}W_{0.2}Au_{0.2}O₂,
(gg) Ru_{0.2}Cr_{0.2}Ti_{0.2}Au_{0.2}Mo_{0.2}O₂,
(hh) Ru_{0.2}Cr_{0.2}Cu_{0.2}Nb_{0.2}W_{0.2}O₂,
(ii) Ru_{0.2}Cr_{0.2}Cu_{0.2}Nb_{0.2}Au_{0.2}O₂,
(jj) Ru_{0.2}Cr_{0.2}Cu_{0.2}Nb_{0.2}Mo_{0.2}O₂,
(kk) Ru_{0.2}Cr_{0.2}Cu_{0.2}W_{0.2}Au_{0.2}O₂,
(II) Ru_{0.2}Cr_{0.2}Cu_{0.2}W_{0.2}Mo_{0.2}O₂,
(mm) Ru_{0.2}Cr_{0.2}Cu_{0.2}Au_{0.2}Mo_{0.2}O₂,
(nn) Ru_{0.2}Cr_{0.2}Nb_{0.2}W_{0.2}Au_{0.2}O₂,
(oo) Ru_{0.2}Cr_{0.2}Nb_{0.2}Au_{0.2}Mo_{0.2}O₂,
(pp) Ru_{0.2}Ti_{0.2}Cu_{0.2}Nb_{0.2}W_{0.2}O₂,
(qq) Ru_{0.2}Ti_{0.2}Cu_{0.2}Nb_{0.2}Au_{0.2}O₂,
(rr) Ru_{0.2}Ti_{0.2}Cu_{0.2}Nb_{0.2}Mo_{0.2}O₂,
(ss) Ru_{0.2}Ti_{0.2}Cu_{0.2}W_{0.2}Au_{0.2}O₂,
(tt) Ru_{0.2}Ti_{0.2}Cu_{0.2}W_{0.2}Mo_{0.2}O₂,
(uu) Ru_{0.2}Ti_{0.2}Cu_{0.2}Au_{0.2}Mo_{0.2}O₂,
(vv) Ru_{0.2}Ti_{0.2}Nb_{0.2}W_{0.2}Au_{0.2}O₂,
(ww) Ru_{0.2}Ti_{0.2}Nb_{0.2}Au_{0.2}Mo_{0.2}O₂,
(xx) Ru_{0.2}Cu_{0.2}Nb_{0.2}W_{0.2}Au_{0.2}O₂,
(yy) Ru_{0.2}Cu_{0.2}Nb_{0.2}Au_{0.2}Mo_{0.2}O₂, or
(zz) Ru_{0.2}Cu_{0.2}W_{0.2}Au_{0.2}Mo_{0.2}O₂.

In some examples the present teachings provide a water electrolyzer device comprising: an anode; a cathode; a proton exchange membrane disposed between the anode and cathode; an anode collector; and a cathode collector. The anode comprises an oxygen evolution reaction (OER) catalyst which comprises a quaternary-doped ruthenium oxide of formula Ruₓ(M1M2M3M4)₁₋ₓO₂, wherein M1 is antimony (Sb), and M2, M3, and M4 are each selected from chromium (Cr), titanium (Ti), copper (Cu), niobium (Nb), tungsten (W), gold (Au), or molybdenum (Mo), or wherein M1, M2, M3, and M4 are each selected from chromium (Cr), titanium (Ti), copper (Cu), niobium (Nb), tungsten (W), gold (Au), or molybdenum (Mo), and x is in a range of 0.2 to 1.0. The quaternary-doped ruthenium dioxide comprises a tetragonal rutile-type lattice structure. The oxygen evolution reaction (OER) catalyst material is stable in acidic media. In some examples, in formula Ruₓ(M1M2M3M4)₁₋ₓO₂, x may be 0.2. In some examples, the quaternary-doped ruthenium dioxide may be Ru_{0.2}M1_{0.2}M2_{0.2}M3_{0.2}M4_{0.2}O₂.

In yet other aspects the present teachings provide a method for enhancing electrochemical stability of oxygen evolution reaction catalysts in acidic media comprising: providing an oxygen evolution reaction (OER) catalyst material to an anode of a water electrolyzer device, wherein the oxygen evolution reaction (OER) catalyst material comprises a quaternary-doped ruthenium dioxide of formula Ruₓ(M1M2M3M4)₁₋ₓO₂, wherein M1 is antimony (Sb), and M2, M3, and M4 are each selected from chromium (Cr), titanium (Ti), copper (Cu), niobium (Nb), tungsten (W), gold (Au), and molybdenum (Mo), or wherein M1, M2, M3, and M4 are each selected from chromium (Cr), titanium (Ti), copper (Cu), niobium (Nb), tungsten (W), gold (Au), or molybdenum (Mo), and x is in a range of 0.2 to 1.0. The oxygen evolution reaction (OER) catalyst material is stable in acidic media. In some examples, the quaternary-doped ruthenium dioxide may be Ru_{0.2}M1_{0.2}M2_{0.2}M3_{0.2}M4_{0.2}O₂.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings wherein:

FIG. 1 is a schematic illustration of a water electrolyzer.

FIG. 2 illustrates a proton exchange membrane (PEM) electrolysis reaction in a water electrolyzer.

FIG. 3 is an illustration of the general crystal lattice structure of the ruthenium dioxide (RuO₂).

FIG. 4 is a graphical chart plotting the percentage of MₓO_{y} with increased stability after M′ doping.

It should be noted that the figures set forth herein are intended to exemplify the general characteristics of the methods, algorithms, and devices among those of the present technology, for the purpose of the description of certain aspects. These figures may not precisely reflect the characteristics of any given aspect and are not necessarily intended to define or limit specific embodiments within the scope of this technology. Further, certain aspects may incorporate features from a combination of figures.

### DETAILED DESCRIPTION

The present disclosure provides quaternary-doped ruthenium dioxide (RuO₂) catalysts having enhanced stability compared to undoped ruthenium dioxide catalysts for oxygen evolution reactions (OER) in water electrolyzer devices.

Water electrolyzers are electrochemical devices designed to split water (H₂O) into hydrogen (H₂) and oxygen (O₂) gases using electricity. These gases can subsequently be utilized for energy storage purposes. This process, known as electrolysis, is critical for green hydrogen production. Proton exchange membrane (PEM) electrolysis involves the use of a PEM water electrolyzer cell equipped with a solid polymer electrolyte responsible for conducting protons, separating product gases, and electrically insulating the electrodes. In acidic media, the reaction occurs within proton exchange membrane (PEM) electrolyzers, following the overall process: H₂O→H₂+½ O₂.

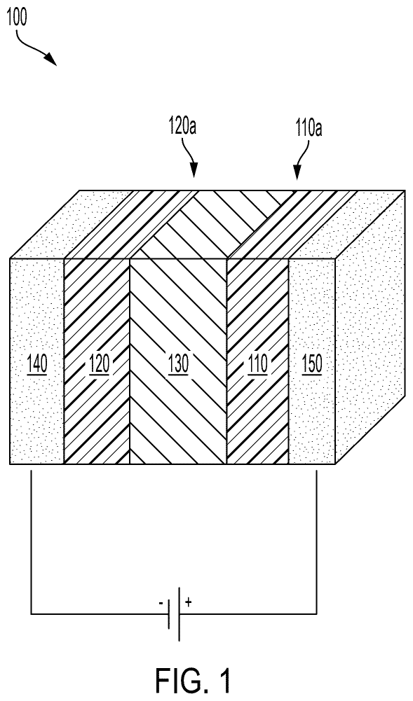

FIG. 1 illustrates a water electrolyzer 100 comprising an anode 110, a cathode 120, a proton exchange membrane (PEM) 130 between the anode 110 and the cathode 120, and cathode and anode current collectors 140 and 150, respectively, which are connected to the negative and positive terminals of a power source. The anode 110, or oxygen-evolving electrode, may be composed of a noble metal oxide catalyst such as iridium oxide (IrO₂), ruthenium dioxide (RuO₂), or a mixed metal oxide suitable for acidic oxygen evolution reaction (OER) conditions. The cathode 120, or hydrogen-evolving electrode, may be made of a hydrogen evolution catalyst such as a platinum (Pt)-containing catalyst or catalyst containing platinum on a carbon support (Pt/C). The proton exchange membrane 130, may be composed of a solid polymer electrolyte configured to conduct protons (H⁺) from the anode to the cathode during operation, such as Nafion®, and is positioned between and interfaces with both the anode 110 and cathode 120 at anodic interface 110a, and cathodic interface 120a respectively. The solid polymer electrolyte comprising the proton exchange membrane 130 serves as the medium through which protons (H⁺) are transported from the anode to the cathode during water electrolysis. The cathodic interface 120a and the anodic interface 110a facilitate proton transport and electrochemical reactions that generate hydrogen gas at the cathode and oxygen gas at the anode. Cathodic and anodic current collectors 140 and 150, respectively, conduct the electrical current required to drive the electrochemical splitting of water.

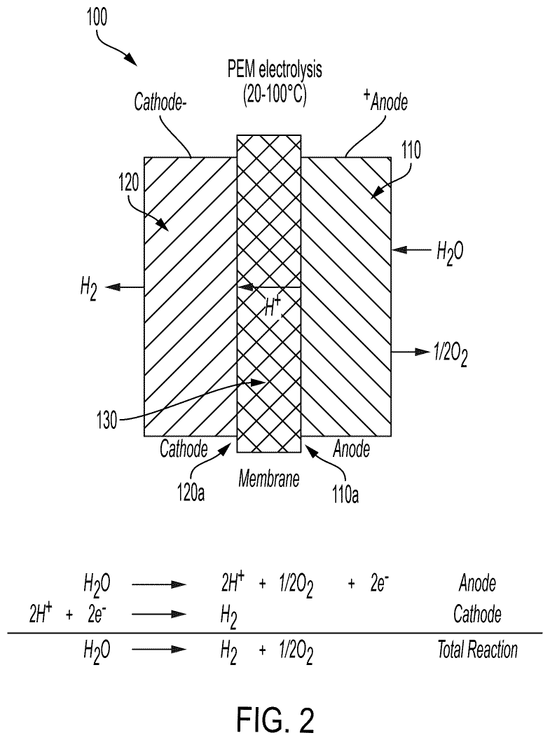

FIG. 2 illustrates the proton exchange membrane (PEM) water electrolysis reaction. The proton exchange membrane 130 is disposed between the anode 110, and the cathode 120. The oxygen evolution reaction (OER), occurring on the anode side of a PEM water electrolyzer, involves the oxidation of liquid water reactant supplied to the catalyst, resulting in the formation of oxygen, protons, and electrons: 2H₂O (liquid)→O₂ (gas)+4H⁺(aqueous)+4e⁻. On the cathode side of a PEM water electrolyzer, the hydrogen evolution reaction (HER) takes place, where the supplied electrons and the protons conducted through the membrane combine to produce gaseous hydrogen: 2H⁺(aqueous)+2e⁻→H₂ (gas). The overall reaction is: H₂O (liquid)→H₂ (gas)+½ O₂ (gas).

The oxygen evolution reaction (OER) catalyst materials of the present disclosure are stable in acidic media. The present inventors discovered that quaternary-doped ruthenium dioxide catalysts exhibit enhanced electrochemical and structural stability under acidic oxygen evolution reaction conditions. The quaternary-doped ruthenium dioxide catalysts of the present disclosure were identified through a high-throughput screening process designed and employed by the present inventors to identify dopants which are effective at stabilizing metal oxides, particularly ruthenium dioxide. Prior to the work of the inventors, single metal doped, or dual metal doped ruthenium oxide systems had been reported, but through atomic simulations, the present inventors were able to identify the quaternary-doped ruthenium dioxide catalysts of the present disclosure.

The present disclosure provides high-entropy ruthenium-based oxide catalysts, comprising multiple metal cations stabilized by lattice doping, exhibiting enhanced catalytic performance and durability under acidic oxygen evolution reaction conditions. “High-entropy” is used in the present disclosure to refer to materials that contain five (5) or more principal elements in equal atomic or nearly equal atomic ratios. The present disclosure relates to high-entropy ruthenium oxides which incorporate at least four (4) different metal cations into a single, stable crystalline oxide lattice of ruthenium. The present disclosure provides an oxygen evolution reaction (OER) catalyst material comprising quaternary-doped ruthenium oxide nanoparticles of formula Ruₓ(M1M2M3M4)₁₋ₓO₂, wherein M1 is antimony (Sb); M2, M3, and M4 are each selected from chromium (Cr), titanium (Ti), copper (Cu), niobium (Nb), tungsten (W), gold (Au), or molybdenum (Mo); and x is in the range of 0.2 to 1.0. In some examples, x may be 0.2. In some examples, the quaternary-doped ruthenium dioxide of the present disclosure may comprise 20 at % Ru, 20 at % M1, 20 at % M2, 20 at % M3, and 20 at % M4, i.e., Ru_{0.2}M1_{0.2}M2_{0.2}M3_{0.2}M4_{0.2}O₂. In some examples, the quaternary-doped ruthenium dioxide is selected from:
(a) Ru_{0.2}Sb_{0.2}Cr_{0.2}Ti_{0.2}Cu_{0.2}O₂,
(b) Ru_{0.2}Sb_{0.2}Cr_{0.2}Ti_{0.2}Nb_{0.2}O₂,
(c) Ru_{0.2}Sb_{0.2}Cr_{0.2}Ti_{0.2}Au_{0.2}O₂,
(d) Ru_{0.2}Sb_{0.2}Cr_{0.2}Ti_{0.2}Mo_{0.2}O₂,
(e) Ru_{0.2}Sb_{0.2}Cr_{0.2}Cu_{0.2}Nb_{0.2}O₂,
(f) Ru_{0.2}Sb_{0.2}Cr_{0.2}Cu_{0.2}W_{0.2}O₂,
(g) Ru_{0.2}Sb_{0.2}Cr_{0.2}Cu_{0.2}Au_{0.2}O₂,
(h) Ru_{0.2}Sb_{0.2}Cr_{0.2}Cu_{0.2}Mo_{0.2}O₂,
(i) Ru_{0.2}Sb_{0.2}Cr_{0.2}Nb_{0.2}Au_{0.2}O₂,
(j) Ru_{0.2}Sb_{0.2}Cr_{0.2}W_{0.2}Au_{0.2}O₂,
(k) Ru_{0.2}Sb_{0.2}Cr_{0.2}Au_{0.2}Mo_{0.2}O₂,
(1) Ru_{0.2}Sb_{0.2}Ti_{0.2}Cu_{0.2}Nb_{0.2}O₂,
(m) Ru_{0.2}Sb_{0.2}Ti_{0.2}Cu_{0.2}W_{0.2}O₂,
(n) Ru_{0.2}Sb_{0.2}Ti_{0.2}Cu_{0.2}Au_{0.2}O₂,
(o) Ru_{0.2}Sb_{0.2}Ti_{0.2}Cu_{0.2}Mo_{0.2}O₂,
(p) Ru_{0.2}Sb_{0.2}Ti_{0.2}Nb_{0.2}Au_{0.2}O₂,
(q) Ru_{0.2}Sb_{0.2}Ti_{0.2}W_{0.2}Au_{0.2}O₂,
(r) Ru_{0.2}Sb_{0.2}Ti_{0.2}Au_{0.2}Mo_{0.2}O₂,
(s) Ru_{0.2}Sb_{0.2}Cu_{0.2}Nb_{0.2}W_{0.2}O₂,
(t) Ru_{0.2}Sb_{0.2}Cu_{0.2}Nb_{0.2}Au_{0.2}O₂,
(u) Ru_{0.2}Sb_{0.2}Cu_{0.2}Nb_{0.2}Mo_{0.2}O₂,
(v) Ru_{0.2}Sb_{0.2}Cu_{0.2}W_{0.2}Au_{0.2}O₂, or
(w) Ru_{0.2}Sb_{0.2}Cu_{0.2}Au_{0.2}Mo_{0.2}O₂.

The present disclosure also provides oxygen evolution reaction (OER) catalysts comprising quaternary-doped ruthenium oxides of formula Ruₓ(M1M2M3M4)₁₋ₓO₂, wherein M1, M2, M3, and M4 are each selected from chromium (Cr), titanium (Ti), copper (Cu), niobium (Nb), tungsten (W), gold (Au), or molybdenum (Mo), and x is in the range of 0.2 to 1.0. In some examples, x may be 0.2. In some examples, the quaternary-doped ruthenium dioxide of the present disclosure may comprise 20 at % Ru, 20% M1, 20% M2, 20% M3, and 20% M4, i.e., Ru_{0.2}M1_{0.2}M2_{0.2}M3_{0.2}M4_{0.2}O₂. In some examples the quaternary-dope ruthenium dioxide is selected from: the quaternary-doped ruthenium dioxide is selected from:
(aa) Ru_{0.2}Cr_{0.2}Ti_{0.2}Cu_{0.2}Nb_{0.2}O₂,
(bb) Ru_{0.2}Cr_{0.2}Ti_{0.2}Cu_{0.2}W_{0.2}O₂,
(cc) Ru_{0.2}Cr_{0.2}Ti_{0.2}Cu_{0.2}Au_{0.2}O₂,
(dd) Ru_{0.2}Cr_{0.2}Ti_{0.2}Cu_{0.2}Mo_{0.2}O₂,
(ee) Ru_{0.2}Cr_{0.2}Ti_{0.2}Nb_{0.2}Au_{0.2}O₂,
(ff) Ru_{0.2}Cr_{0.2}Ti_{0.2}W_{0.2}Au_{0.2}O₂,
(gg) Ru_{0.2}Cr_{0.2}Ti_{0.2}Au_{0.2}Mo_{0.2}O₂,
(hh) Ru_{0.2}Cr_{0.2}Cu_{0.2}Nb_{0.2}W_{0.2}O₂,
(ii) Ru_{0.2}Cr_{0.2}Cu_{0.2}Nb_{0.2}Au_{0.2}O₂,
(jj) Ru_{0.2}Cr_{0.2}Cu_{0.2}Nb_{0.2}Mo_{0.2}O₂,
(kk) Ru_{0.2}Cr_{0.2}Cu_{0.2}W_{0.2}Au_{0.2}O₂,
(II) Ru_{0.2}Cr_{0.2}Cu_{0.2}W_{0.2}Mo_{0.2}O₂,
(mm) Ru_{0.2}Cr_{0.2}Cu_{0.2}Au_{0.2}Mo_{0.2}O₂,
(nn) Ru_{0.2}Cr_{0.2}Nb_{0.2}W_{0.2}Au_{0.2}O₂,
(oo) Ru_{0.2}Cr_{0.2}Nb_{0.2}Au_{0.2}Mo_{0.2}O₂,
(pp) Ru_{0.2}Ti_{0.2}Cu_{0.2}Nb_{0.2}W_{0.2}O₂,
(qq) Ru_{0.2}Ti_{0.2}Cu_{0.2}Nb_{0.2}Au_{0.2}O₂,
(rr) Ru_{0.2}Ti_{0.2}Cu_{0.2}Nb_{0.2}Mo_{0.2}O₂,
(ss) Ru_{0.2}Ti_{0.2}Cu_{0.2}W_{0.2}Au_{0.2}O₂,
(tt) Ru_{0.2}Ti_{0.2}Cu_{0.2}W_{0.2}Mo_{0.2}O₂,
(uu) Ru_{0.2}Ti_{0.2}Cu_{0.2}Au_{0.2}Mo_{0.2}O₂,
(vv) Ru_{0.2}Ti_{0.2}Nb_{0.2}W_{0.2}Au_{0.2}O₂,
(ww) Ru_{0.2}Ti_{0.2}Nb_{0.2}Au_{0.2}Mo_{0.2}O₂,
(xx) Ru_{0.2}Cu_{0.2}Nb_{0.2}W_{0.2}Au_{0.2}O₂,
(yy) Ru_{0.2}Cu_{0.2}Nb_{0.2}Au_{0.2}Mo_{0.2}O₂, or
(zz) Ru_{0.2}Cu_{0.2}W_{0.2}Au_{0.2}Mo_{0.2}O₂.

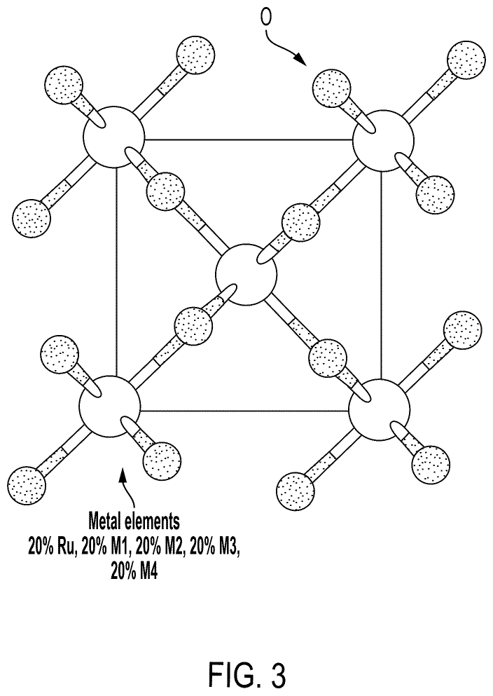

FIG. 3 illustrates a schematic representation of a high-entropy ruthenium oxide crystal structure of the present disclosure having a tetragonal rutile-type lattice structure. The structure includes metal cation sites occupied by a uniform distribution of five metal elements—20 at % ruthenium (Ru), and 20 at % each of four additional metal elements (M1, M2, M3, M4)—forming a single-phase solid solution. Oxygen anions (O) are shown coordinated around the metal centers, forming distorted octahedral units typical of a rutile structure. This configuration represents the quaternary-doped ruthenium metal oxide system of the present disclosure designed for enhanced catalytic activity and stability under acidic oxygen evolution reaction (OER) conditions.

The quaternary-doped ruthenium oxide nanoparticles of the present disclosure can be synthesized by known methods such as liquid phase synthesis including sol-gel and co-precipitation, and wet impregnation methods. In some examples, the quaternary-doped ruthenium oxide nanoparticles of the present disclosure can be synthesized by a method for forming single phase multi-element oxide particles described in the co-pending U.S. application Ser. No. 19/196,842 entitled “Method for Synthesizing Multi-Element Metal Oxide Nanoparticles” filed on May 2, 2025. The method involves dissolving organometallic precursors of the metals, each having the formula M(acac)n in an organic solvent; impregnating the organometallic precursors on a support; reducing the organometallic precursors to obtain alloy nanoparticles on the support; and annealing the alloy nanoparticles and support to remove the support and to convert the alloy nanoparticles to oxide nanoparticles. In the formula, M represents the metal, i.e., Ru, M1, M2, M3, or M4; acac represents acetylacetonate, a bidentate ligand, used in the preparation of precursor solutions for catalysts nanoparticles; and n is an integer representing the number of acac ligands bound to the respective metal. The entire disclosure of the co-pending U.S. application Ser. No. 19/196,842 entitled “Method for Synthesizing Multi-Element Metal Oxide Nanoparticles” filed on May 2, 2025, which is commonly assigned and concurrently filed herewith, and is incorporated herein by reference in its entirety.

The oxygen evolution reaction (OER) catalysts comprising quaternary-doped ruthenium oxides of the present disclosure can be used in a water electrolyzer device comprising an anode; a cathode; a proton exchange membrane disposed between the anode and cathode; an anode collector; and a cathode collector. The oxygen evolution reaction (OER) catalysts comprising quaternary-doped ruthenium oxides of the present disclosure can be provided to the anode where the oxygen evolution reaction (OER) catalyst comprises the quaternary-doped ruthenium oxides of formula Ruₓ(M1M2M3M4)₁₋ₓO₂, wherein M1 is antimony (Sb), and M2, M3, and M4 are each selected from chromium (Cr), titanium (Ti), copper (Cu), niobium (Nb), tungsten (W), gold (Au), or molybdenum (Mo), or wherein M1, M2, M3, and M4 are each selected from chromium (Cr), titanium (Ti), copper (Cu), niobium (Nb), tungsten (W), gold (Au), or molybdenum (Mo), and x is in the range of 0.2 to 1.0. In some examples, x may be 0.2. In some examples, the quaternary-doped ruthenium dioxide of the present disclosure may comprise 20 at % Ru, 20 at % M1, 20 at % M2, 20 at % M3, and 20 at % M4, i.e., Ru_{0.2}M1_{0.2}M2_{0.2}M3_{0.2}M4_{0.2}O₂.

The present disclosure also provides a method for enhancing the electrochemical stability of oxygen evolution reaction (OER) catalysts in acidic media comprising providing an oxygen evolution reaction (OER) catalyst material to an anode of a water electrolyzer device, wherein the oxygen evolution (OER) catalyst material comprises a quaternary-doped ruthenium dioxide of formula Ruₓ(M1M2M3M4)₁₋ₓO₂, wherein M1 is antimony (Sb), and M2, M3, and M4 are each selected from chromium (Cr), titanium (Ti), copper (Cu), niobium (Nb), tungsten (W), gold (Au), or molybdenum (Mo), or wherein M1, M2, M3, and M4 are each selected from chromium (Cr), titanium (Ti), copper (Cu), niobium (Nb), tungsten (W), gold (Au), or molybdenum (Mo); and x is in a range of 0.2 to 1.0.

### EXAMPLES

Various aspects of the present disclosure are further illustrated with respect to the following examples. It is to be understood that these examples are provided to illustrate specific embodiments of the present disclosure and should not be construed as limiting the scope of the present disclosure in or to any particular aspect.

### Example 1. Stability Calculations

Metal oxides (MₓO_{y}) were doped with different metal elements (M′) to determine how the various doping metals affect the thermodynamic stability of the metal oxide in the reaction condition. Each metal oxide (MₓO_{y}) consisted of a metal M chosen from a wide range of elements with specific oxidation states and oxygen, with stoichiometric ratios where x is between 1 and 2, inclusive, and y is between 1 and 3, inclusive. In particular, M represents: ‘TI⁺¹’, ‘Ag⁺¹’, ‘Cu⁺¹’, ‘Sc⁺²’, ‘Ce⁺²’, ‘La⁺²’, ‘Pb⁺²’, ‘TI⁺²’, ‘Sn⁺²’, ‘Pd⁺²’, ‘Pr⁺²’, ‘Nb⁺²’, ‘Cu⁺²’, ‘Co⁺²’, ‘Eu⁺²’, ‘Mn⁺²’, ‘Ti⁺²’, ‘Cr⁺²’, ‘V⁺²’, ‘Fe⁺²’, ‘Cr⁺³’, ‘Mn⁺³’, ‘Nb⁺³’, ‘Ce⁺³’, ‘Ti⁺³’, ‘V⁺³’, ‘Rh⁺³’, ‘Pt⁺³’, ‘Sb⁺³’, ‘Pb⁺³’, ‘Ge⁺³’, ‘Mn⁺⁴’, ‘Sb⁺⁴’, ‘V⁺⁴’, ‘Ir⁺⁴’, ‘OS⁺⁴’, ‘Re⁺⁴’, ‘Cr⁺⁴’, ‘Tc⁺⁴’, ‘Mo⁺⁴’, ‘Nb⁺⁴’, ‘Ru⁺⁴’, ‘W⁺⁵’, ‘V⁺⁵’, ‘Ir⁺⁶’, ‘Re⁺⁶’. The value associated with a metal element is its valence charge in the corresponding metal oxide.

For each MₓO_{y} compound, a dopant M′ was systematically introduced by lattice doping. M′ represents ‘Li⁺¹’, ‘Na⁺¹’, ‘K⁺¹’, ‘Rb⁺¹’, ‘Cs₊₁’, ‘Mg⁺²’, ‘Ca⁺²’, ‘Sr⁺²’, ‘Ni⁺²’, ‘Zn⁺²’, ‘Cd⁺²’, ‘Hg⁺²’, ‘Sc⁺³’, ‘y⁺³’, ‘Al⁺³’, ‘Bi⁺³’, ‘La⁺³’, ‘Pr⁺³’, ‘Nd⁺³’, ‘Sm⁺³’, ‘Eu⁺³’, ‘Gd⁺³’, ‘Tb⁺³’, ‘Dy⁺³’, ‘Ho⁺³’, ‘Er⁺³’, ‘Tm⁺³’, ‘Lu⁺³’, ‘Zr⁺⁴’, ‘Hf⁺⁴’, ‘Ta⁺⁵’, ‘Cr⁺⁶’, ‘Cu⁺¹’, ‘Ag⁺¹’, ‘Mn⁺²’, ‘Fe⁺²’, ‘Co⁺²’, ‘Cu⁺²’, ‘Pd⁺²’, ‘Au⁺²’, ‘Pb⁺²’, ‘Cr⁺³’, ‘Mn⁺³’, ‘Rh⁺³’, ‘V⁺⁵’, ‘Re⁺⁵’, ‘Fe⁺³’, ‘Cu⁺³’, ‘Au⁺³’, ‘Ga⁺³’, ‘In⁺³’, ‘Ti⁺⁴’, ‘Sn⁺⁴’, ‘Ge⁺⁴’, ‘Nb⁺⁵’, ‘Sb⁺⁵’, ‘Cr⁺⁶’, ‘Mo⁺⁶’, ‘W⁺⁶’, ‘Re⁺⁷’. The value associated with a metal element is its valence charge in the corresponding metal oxide.

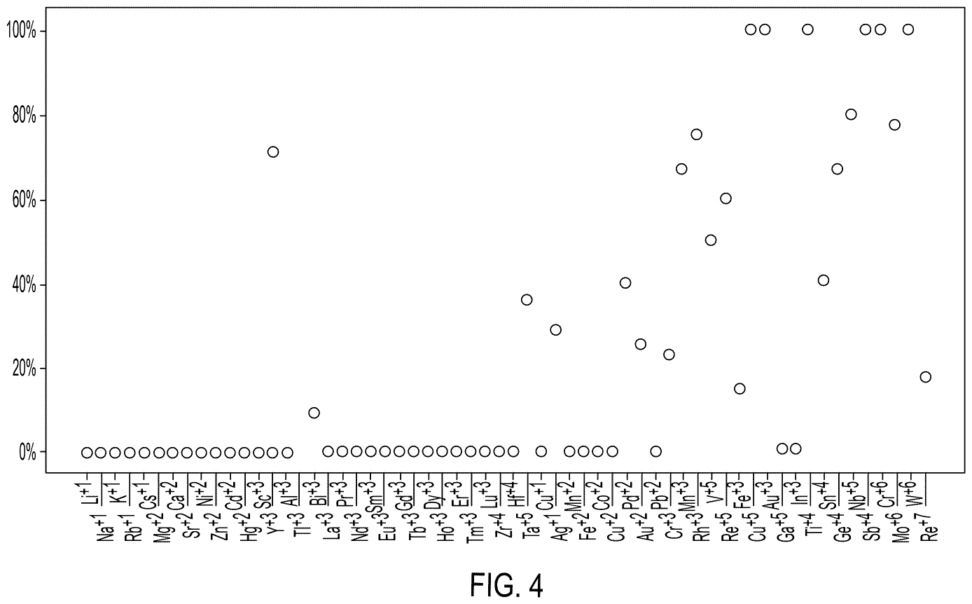

To assess the overall effect of each dopant, the percentage of MₓO_{y} oxides that became more stable after being doped with a given M′ was calculated. These percentages are provided in the chart in FIG. 4, with the x-axis representing different dopant species (M′) and the y-axis indicating how often doping with that element led to increased stability. As can be seen in FIG. 4, the percentage of MₓO_{y} with increased stability after doping with Sb, Cr, Ti, Cu, Nb, W, Au, or Mo exceeds 75%. Remarkably, doping with Cu, Au, Ti, Sb, Cr, or W leads to the stability enhancement of all MₓO_{y}.

### Example 2. Predicted Stability of Quaternary-Doped Ruthenium Oxides

Various combinations of the metals found to enhance the stability of metal oxides (MₓO_{y}), i.e., Sb, Cr, Ti, Cu, Nb, W, Au, or Mo, were doped into RuO₂ to create compounds having the formula Ru_{0.2}M1_{0.2}M2_{0.2}M3_{0.2}M4_{0.2}O₂, wherein each of M1, M2, M3, and M4 were selected from Sb, Cr, Ti, Cu, Nb, W, Au, or Mo. High-throughput screening was conducted using CHGNET (Crystal Hamiltonian Graph Neural Network) (https://chgnet.lbl.gov), a pre-trained machine learning package for performing geometry optimizations and predicting material properties. Calculations with CHGNET determined the predicted stability of each doped composition. Noting that the instability of RuO₂ is due to its dissolution in strong acid conditions, removing one Ru atom from the stoichiometric structure mimics the dissolution process. Thus, the energy required to remove one Ru atom from the structure was calculated and used as the indicator for catalyst stability. A larger energy indicates a more stable structure. Additionally, the energy difference required to remove one Ru atom from the doped system and undoped system was calculated. If the difference is a positive value, it indicates that the doped system Ru_{0.2}M1_{0.2}M2_{0.2}M3_{0.2}M4_{0.2}O₂ is more stable than undoped RuO₂, if the difference is a negative value, it indicates that the doped system Ru_{0.2}M1_{0.2}M2_{0.2}M3_{0.2}M4_{0.2}O₂ is less stable than RuO₂. Table 1 below shows the energy difference for each doped system.

TABLE 1

| M1 | M2 | M2 | M4 | Energy difference (eV) |
|---|---|---|---|---|
| Sb | Cr | Ti | Cu | 3.1421059131622315 |
| Sb | Cr | Ti | Nb | 0.7465424537658691 |
| Sb | Cr | Ti | W | −0.17471 |
| Sb | Cr | Ti | Au | 2.1393832683563234 |
| Sb | Cr | Ti | Mo | 0.096228 |
| Sb | Cr | Cu | Nb | 2.181333541870117 |
| Sb | Cr | Cu | W | 1.058995246887207 |
| Sb | Cr | Cu | Au | 2.8891304969787597 |
| Sb | Cr | Cu | Mo | 1.596181535720825 |
| Sb | Cr | Nb | W | −1.14163 |
| Sb | Cr | Nb | Au | 1.275428295135498 |
| Sb | Cr | Nb | Mo | −0.80979 |
| Sb | Cr | W | Au | 0.7042346477508545 |
| Sb | Cr | W | Mo | −1.2154 |
| Sb | Cr | Au | Mo | 0.5554788112640381 |
| Sb | Ti | Cu | Nb | 1.9944841384887695 |
| Sb | Ti | Cu | W | 1.8532765865325929 |
| Sb | Ti | Cu | Au | 2.7070485591888427 |
| Sb | Ti | Cu | Mo | 1.399994134902954 |
| Sb | Ti | Nb | W | −1.7523 |
| Sb | Ti | Nb | Au | 0.871648 |
| Sb | Ti | Nb | Mo | −1.29972 |
| Sb | Ti | W | Au | 0.12281384468078613 |
| Sb | Ti | W | Mo | −1.86823 |
| Sb | Ti | Au | Mo | 0.49296131134033205 |
| Sb | Cu | Nb | W | 0.32454357147216795 |
| Sb | Cu | Nb | Au | 2.9492947101593017 |
| Sb | Cu | Nb | Mo | 0.9111836910247803 |
| Sb | Cu | W | Au | 1.7564419269561768 |
| Sb | Cu | W | Mo | −0.78356 |
| Sb | Cu | Au | Mo | 2.0165876865386965 |
| Sb | Nb | W | Au | −1.82891 |
| Sb | Nb | W | Mo | −2.16121 |
| Sb | Nb | Au | Mo | −0.0659 |
| Sb | W | Au | Mo | −0.78396 |
| Cr | Ti | Cu | Nb | 2.9508097648620604 |
| Cr | Ti | Cu | W | 2.8110844612121584 |
| Cr | Ti | Cu | Au | 2.794659 |
| Cr | Ti | Cu | Mo | 2.201463985443115 |
| Cr | Ti | Nb | W | −0.58847 |
| Cr | Ti | Nb | Au | 2.296185 |
| Cr | Ti | Nb | Mo | −0.27671 |
| Cr | Ti | W | Au | 1.6643659114837646 |
| Cr | Ti | W | Mo | −0.70204 |
| Cr | Ti | Au | Mo | 1.4588237762451173 |
| Cr | Cu | Nb | W | 1.5383222579956055 |
| Cr | Cu | Nb | Au | 2.445232963562012 |
| Cr | Cu | Nb | Mo | 1.5194759368896484 |
| Cr | Cu | W | Au | 2.190755271911621 |
| Cr | Cu | W | Mo | 0.9391462326049804 |
| Cr | Cu | Au | Mo | 1.868559217453003 |
| Cr | Nb | W | Au | 1.0148607254028321 |
| Cr | Nb | W | Mo | −1.30528 |
| Cr | Nb | Au | Mo | 1.2257309436798096 |
| Cr | W | Au | Mo | −0.19714 |
| Ti | Cu | Nb | W | 0.9419846534729004 |
| Ti | Cu | Nb | Au | 2.5912127017974855 |
| Ti | Cu | Nb | Mo | 1.6552099227905273 |
| Ti | Cu | W | Au | 2.245528984069824 |
| Ti | Cu | W | Mo | 0.4165633201599121 |
| Ti | Cu | Au | Mo | 1.736532 |
| Ti | Nb | W | Au | 0.172589 |
| Ti | Nb | W | Mo | −1.90873 |
| Ti | Nb | Au | Mo | 0.7346423625946045 |
| Ti | W | Au | Mo | −0.21447 |
| Cu | Nb | W | Au | 2.4692299365997314 |
| Cu | Nb | W | Mo | −0.51914 |
| Cu | Nb | Au | Mo | 2.8566046714782716 |
| Cu | W | Au | Mo | 0.7219045162200928 |
| Nb | W | Au | Mo | −0.49435 |

Based on their improved stability, when incorporated at the anode of a proton exchange membrane (PEM) water electrolyzer, the high-entropy oxides of the present disclosure can mitigate the dissolution and degradation challenges associated with conventional RuO₂ while maintaining high intrinsic activity and long-term operational stability.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple embodiments having stated features is not intended to exclude other embodiments having additional features, or other embodiments incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or particular system is included in at least one embodiment or aspect. The appearances of the phrase “in one aspect” (or variations thereof) are not necessarily referring to the same aspect or embodiment. It should be also understood that the various method steps discussed herein do not have to be carried out in the same order as depicted, and not each method step is required in each aspect or embodiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. An oxygen evolution reaction (OER) catalyst material comprising a quaternary-doped ruthenium dioxide nanoparticles of formula Ruₓ(M1M2M3M4)₁₋ₓO₂, wherein:
M1 is antimony (Sb);
M2, M3, and M4 are each selected from chromium (Cr), titanium (Ti), copper (Cu), niobium (Nb), tungsten (W), gold (Au), or molybdenum (Mo); and
x is in a range of 0.2 to 1.0.

2. The oxygen evolution reaction (OER) catalyst material according to claim 1, wherein the quaternary-doped ruthenium dioxide comprises a tetragonal rutile-type lattice structure.

3. The oxygen evolution reaction (OER) catalyst material according to claim 1, which is stable in acidic media.

4. The oxygen evolution reaction (OER) catalyst material according to claim 1, wherein x is 0.2.

5. The oxygen evolution reaction (OER) catalyst material according to claim 1, wherein the quaternary-doped ruthenium dioxide is Ru_{0.2}M1_{0.2}M2_{0.2}M3_{0.2}M4_{0.2}O₂.

6. The oxygen evolution reaction (OER) catalyst material according to claim 1, wherein the quaternary-doped ruthenium dioxide is selected from:
(a) Ru_{0.2}Sb_{0.2}Cr_{0.2}Ti_{0.2}Cu_{0.2}O₂,
(b) Ru_{0.2}Sb_{0.2}Cr_{0.2}Ti_{0.2}Nb_{0.2}O₂,
(c) Ru_{0.2}Sb_{0.2}Cr_{0.2}Ti_{0.2}Au_{0.2}O₂,
(d) Ru_{0.2}Sb_{0.2}Cr_{0.2}Ti_{0.2}Mo_{0.2}O₂,
(e) Ru_{0.2}Sb_{0.2}Cr_{0.2}Cu_{0.2}Nb_{0.2}O₂,
(f) Ru_{0.2}Sb_{0.2}Cr_{0.2}Cu_{0.2}W_{0.2}O₂,
(g) Ru_{0.2}Sb_{0.2}Cr_{0.2}Cu_{0.2}Au_{0.2}O₂,
(h) Ru_{0.2}Sb_{0.2}Cr_{0.2}Cu_{0.2}Mo_{0.2}O₂,
(i) Ru_{0.2}Sb_{0.2}Cr_{0.2}Nb_{0.2}Au_{0.2}O₂,
(j) Ru_{0.2}Sb_{0.2}Cr_{0.2}W_{0.2}Au_{0.2}O₂,
(k) Ru_{0.2}Sb_{0.2}Cr_{0.2}Au_{0.2}Mo_{0.2}O₂,
(l) Ru_{0.2}Sb_{0.2}Ti_{0.2}Cu_{0.2}Nb_{0.2}O₂,
(m) Ru_{0.2}Sb_{0.2}Ti_{0.2}Cu_{0.2}W_{0.2}O₂,
(n) Ru_{0.2}Sb_{0.2}Ti_{0.2}Cu_{0.2}Au_{0.2}O₂,
(o) Ru_{0.2}Sb_{0.2}Ti_{0.2}Cu_{0.2}Mo_{0.2}O₂,
(p) Ru_{0.2}Sb_{0.2}Ti_{0.2}Nb_{0.2}Au_{0.2}O₂,
(q) Ru_{0.2}Sb_{0.2}Ti_{0.2}W_{0.2}Au_{0.2}O₂,
(r) Ru_{0.2}Sb_{0.2}Ti_{0.2}Au_{0.2}Mo_{0.2}O₂,
(s) Ru_{0.2}Sb_{0.2}Cu_{0.2}Nb_{0.2}W_{0.2}O₂,
(t) Ru_{0.2}Sb_{0.2}Cu_{0.2}Nb_{0.2}Au_{0.2}O₂,
(u) Ru_{0.2}Sb_{0.2}Cu_{0.2}Nb_{0.2}Mo_{0.2}O₂,
(v) Ru_{0.2}Sb_{0.2}Cu_{0.2}W_{0.2}Au_{0.2}O₂, or
(w) Ru_{0.2}Sb_{0.2}Cu_{0.2}Au_{0.2}Mo_{0.2}02.

7. An oxygen evolution reaction (OER) catalyst material comprising nanoparticles of quaternary-doped ruthenium dioxide of formula Ruₓ(M1M2M3M4)₁₋ₓO₂, wherein:
M1, M2, M3, and M4 are each selected from chromium (Cr), titanium (Ti), copper (Cu), niobium (Nb), tungsten (W), gold (Au), or molybdenum (Mo); and
x is in a range of 0.2 to 1.0.

8. The oxygen evolution reaction (OER) catalyst material according to claim 7, wherein the quaternary-doped ruthenium dioxide comprises a tetragonal rutile-type lattice structure.

9. The oxygen evolution reaction (OER) catalyst material according to claim 7, which is stable in acidic media.

10. The oxygen evolution reaction (OER) catalyst material according to claim 7, wherein x is 0.2.

11. The oxygen evolution reaction (OER) catalyst material according to claim 7, wherein the quaternary-doped ruthenium dioxide is Ru_{0.2}M1_{0.2}M2_{0.2}M3_{0.2}M4_{0.2}O₂.

12. The oxygen evolution reaction (OER) catalyst material according to claim 7, wherein the quaternary-doped ruthenium dioxide is selected from:
(aa) Ru_{0.2}Cr_{0.2}Ti_{0.2}Cu_{0.2}Nb_{0.2}O₂,
(bb) Ru_{0.2}Cr_{0.2}Ti_{0.2}Cu_{0.2}W_{0.2}O₂,
(cc) Ru_{0.2}Cr_{0.2}Ti_{0.2}Cu_{0.2}Au_{0.2}O₂,
(dd) Ru_{0.2}Cr_{0.2}Ti_{0.2}Cu_{0.2}Mo_{0.2}O₂,
(ee) Ru_{0.2}Cr_{0.2}Ti_{0.2}Nb_{0.2}Au_{0.2}O₂,
(ff) Ru_{0.2}Cr_{0.2}Ti_{0.2}W_{0.2}Au_{0.2}O₂,
(gg) Ru_{0.2}Cr_{0.2}Ti_{0.2}Au_{0.2}Mo_{0.2}O₂,
(hh) Ru_{0.2}Cr_{0.2}Cu_{0.2}Nb_{0.2}W_{0.2}O₂,
(ii) Ru_{0.2}Cr_{0.2}Cu_{0.2}Nb_{0.2}Au_{0.2}O₂,
(jj) Ru_{0.2}Cr_{0.2}Cu_{0.2}Nb_{0.2}Mo_{0.2}O₂,
(kk) Ru_{0.2}Cr_{0.2}Cu_{0.2}W_{0.2}Au_{0.2}O₂,
(II) Ru_{0.2}Cr_{0.2}Cu_{0.2}W_{0.2}Mo_{0.2}O₂,
(mm) Ru_{0.2}Cr_{0.2}Cu_{0.2}Au_{0.2}Mo_{0.2}O₂,
(nn) Ru_{0.2}Cr_{0.2}Nb_{0.2}W_{0.2}Au_{0.2}O₂,
(oo) Ru_{0.2}Cr_{0.2}Nb_{0.2}Au_{0.2}Mo_{0.2}O₂,
(pp) Ru_{0.2}Ti_{0.2}Cu_{0.2}Nb_{0.2}W_{0.2}O₂,
(qq) Ru_{0.2}Ti_{0.2}Cu_{0.2}Nb_{0.2}Au_{0.2}O₂,
(rr) Ru_{0.2}Ti_{0.2}Cu_{0.2}Nb_{0.2}Mo_{0.2}O₂,
(ss) Ru_{0.2}Ti_{0.2}Cu_{0.2}W_{0.2}Au_{0.2}O₂,
(tt) Ru_{0.2}Ti_{0.2}Cu_{0.2}W_{0.2}Mo_{0.2}O₂,
(uu) Ru_{0.2}Ti_{0.2}Cu_{0.2}Au_{0.2}Mo_{0.2}O₂,
(vv) Ru_{0.2}Ti_{0.2}Nb_{0.2}W_{0.2}Au_{0.2}O₂,
(ww) Ru_{0.2}Ti_{0.2}Nb_{0.2}Au_{0.2}Mo_{0.2}O₂,
(xx) Ru_{0.2}Cu_{0.2}Nb_{0.2}W_{0.2}Au_{0.2}O₂,
(yy) Ru_{0.2}Cu_{0.2}Nb_{0.2}Au_{0.2}Mo_{0.2}O₂, or
(zz) Ru_{0.2}Cu_{0.2}W_{0.2}Au_{0.2}Mo_{0.2}O₂.

13. A water electrolyzer device comprising:
an anode;
a cathode;
a proton exchange membrane disposed between the anode and cathode;
an anode collector; and
a cathode collector,
wherein the anode comprises an oxygen evolution reaction (OER) catalyst which comprises a quaternary-doped ruthenium dioxide of formula Ruₓ(M1M2M3M4)₁₋ₓO₂, wherein M1 is antimony (Sb), and M2, M3, and M4 are each selected from chromium (Cr), titanium (Ti), copper (Cu), niobium (Nb), tungsten (W), gold (Au), or molybdenum (Mo), or wherein M1, M2, M3, and M4 are each selected from chromium (Cr), titanium (Ti), copper (Cu), niobium (Nb), tungsten (W), gold (Au), or molybdenum (Mo), and x is in a range of 0.2 to 1.0.

14. The water electrolyzer device according to claim 13, wherein the quaternary-doped ruthenium dioxide comprises a tetragonal rutile-type lattice structure.

15. The water electrolyzer device according to claim 13, wherein the oxygen evolution reaction (OER) catalyst is stable in acidic media.

16. The water electrolyzer device according to claim 13, wherein x is 0.2.

17. The water electrolyzer device according to claim 13, wherein the quaternary-doped ruthenium dioxide is Ru_{0.2}M1_{0.2}M2_{0.2}M3_{0.2}M4_{0.2}O₂.

18. A method for enhancing electrochemical stability of oxygen evolution reaction catalysts in acidic media comprising:
providing an oxygen evolution reaction (OER) catalyst material to an anode of a water electrolyzer device, wherein the oxygen evolution reaction (OER) catalyst material comprises a quaternary-doped ruthenium dioxide of formula Ruₓ(M1M2M3M4)₁₋ₓO₂, wherein M1 is antimony (Sb), and M2, M3, and M4 are each selected from chromium (Cr), titanium (Ti), copper (Cu), niobium (Nb), tungsten (W), gold (Au), or molybdenum (Mo), or wherein M1, M2, M3, and M4 are each selected from chromium (Cr), titanium (Ti), copper (Cu), niobium (Nb), tungsten (W), gold (Au), or molybdenum (Mo), and x is in a range of 0.2 to 1.0.

19. The method according to claim 18, wherein the oxygen evolution reaction (OER) catalyst material is stable in acidic media.

20. The method according to claim 18, wherein the quaternary-doped ruthenium dioxide is Ru_{0.2}M1_{0.2}M2_{0.2}M3_{0.2}M4_{0.2}O₂.
